(19) United States
(12) Patent Application Publication
(10) Pub. No.: US 2010/0270967 A1
(43) Pub. Date: Oct. 28, 2010

(54) APPARATUS FOR HARVESTING ENERGY FROM MICROWAVE

(75) Inventors: In-Kui CHO, Daejeon (KR); Jung-Ick MOON, Daejeon (KR); Je-Hoon YUN, Daejeon (KR); Jong-Hwa KWON, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/696,442

(22) Filed: Jan. 29, 2010

(30) Foreign Application Priority Data
Apr. 28, 2009 (KR) 10-2009-0037190

(51) Int. Cl. H01M 10/46; H02J 7/00

(52) U.S. Cl. 320/101; 320/107

(57) ABSTRACT

Provided is an apparatus for harvesting energy from a microwave. An apparatus for harvesting energy from a microwave in an electricity storage system of a building, includes: a plurality of rectennas arranged with a predetermined length according to characteristic of microwave to be absorbed, and configured to collect microwave in the atmosphere and convert the collected microwave into electric energy; a current converter configured to convert the electric energy outputted from the rectennas into a storable current; and a charging tank configured to store the current outputted from the current converter, wherein the arranged rectennas are attached to an outer wall of the building, and the rectennas attached to the top of the building are printed in a transparent conductor on the surface of a solar cell.

### CROSS-REFERENCE(S) TO RELATED APPLICATIONS

The present invention claims priority of Korean Patent Application No(s). 10-2009-0037190, filed on Apr. 28, 2009, which is incorporated herein by reference in its entirety.

### BACKGROUND OF THE INVENTION

1. Field of the Invention

The present invention relates to an energy harvesting apparatus; and, more particularly, to an apparatus for harvesting energy from a microwave.

2. Description of Related Art

Generally, a microwave is energy generated from a flow of electricity and magnetism and is also called a radio wave. That is, an electric field and a magnetic field are simultaneously generated around an area where vibration occurs while electricity is flowing, and a wave generated while the electric field and the magnetic field vary periodically is called a microwave. Such a microwave exists everywhere.

A microwave may be classified into electric fields generated by a voltage, and magnetic fields generated by a current. The microwave is generated from any product using electricity, for example, power transmission/distribution lines, electric appliances, and so on.

An electric field is generated in a perpendicular direction from a source in a straight-line shape and is easily removed or weakened by trees, buildings, human being's skins, and so on. A magnetic field is formed in a circular shape around a source and is not easily removed or weakened by certain objects or materials.

A microwave is classified into a gamma ray, an X ray, an ultraviolet ray, a visible ray (light), an infrared ray, and a radio wave (ultrahigh frequency radio wave, high frequency radio wave, low frequency radio wave, and very low frequency radio wave) in descending order of frequency. Accordingly, the radio wave refers to a microwave with a frequency of 3,000 GHz or less, and it is indispensable to daily life because it is used in various types. However, the very low frequency radio wave and the low frequency radio wave generate an electric field and a magnetic field. Hence, if a human body is exposed to the very low frequency radio wave or the low frequency radio wave for a long time, a body temperature is changed and a biorhythm is unbalanced, which is very likely to cause diseases. For example, search results were reported that the very low frequency radio wave and the low frequency radio wave might cause the reduction in the number of sperms for men, and might cause menstrual irregularity and birth defects for women. Furthermore, since a brain tumor might be caused in serious cases, the World Health Organization (WHO) conducted investigations, and harmfulness of the microwave has been revealed.

Examples of microwaves around our surroundings may include effective isotropically radiated power (hereinafter, referred to as “EIRP”) radiated from a near base station, a magnetic field generated around a high pressure power station or a transformer substation, and strong electromagnetic interference (hereinafter, referred to as “EMI”) generated in communication/electricity systems with high power consumption. Therefore, there is a need for methods for ensuring safety from the microwave environmental problems. Moreover, methods for reproducing harmful microwave into electric energy have attracted attention.

Meanwhile, due to concerns about exhaustion of finite resources such as petroleum energy, there is a need for methods for ensuring stable and regular energy. The microwave always exists around us. Therefore, wireless power transmission and energy reproduction technologies using microwave and radio wave have attracted attention as new research fields due to the exhaustion of fossil energy.

A representative new energy reproduction technology is to use a solar heat. The technology using a solar heat is applied in many places. However, an energy reproduction technology using a solar heat has a large number of variable parameters. Sufficient energy can be obtained during the daytime, but energy is consumed at night. Also, the energy efficiency is changed according to climatic condition. Specifically, efficiency of energy is high when a solar heat is strong, but it is low when it rains or snows. An amount of energy produced is also always varied. Moreover, since the sun always moves from the east to the west, optimal energy collection is difficult.

Like the solar heat, a wind power also has a large number of variable parameters. A blowing wind rotates blades of a wind power generator and an electric generator is operated by the rotation of the blades, resulting in production of energy. However, when no wind blows, energy cannot be produced. Also, the wind power generator must be installed in a windy area. Like this, location requirements for the wind power generator are hard to meet.

Therefore, there is a need for stable energy supply, instead of variable energy production of a solar heat or wind power.

### SUMMARY OF THE INVENTION

An embodiment of the present invention is directed to providing an apparatus for ensuring a stable energy source.

Another embodiment of the present invention is directed to providing an energy harvesting apparatus capable of solving energy harvesting limitation caused by existence of variable parameters and so on.

Another embodiment of the present invention is directed to providing an energy harvesting apparatus capable of reducing influence of microwave on a human body.

In accordance with an aspect of the present invention, there is provided an apparatus for harvesting energy from a microwave in an electricity storage system of a building, which includes: a plurality of rectennas arranged with a predetermined length according to characteristic of microwave to be absorbed, and configured to collect microwave in the atmosphere and convert the collected microwave into electric energy; a current converter configured to convert the electric energy outputted from the rectennas into a storable current; and a charging tank configured to store the current outputted from the current converter, wherein the arranged rectennas are attached to an outer wall of the building, and the rectennas attached to the top of the building are printed in a transparent conductor on the surface of a solar cell.

In accordance with another aspect of the present invention, there is provided a system for harvesting energy from a microwave in an electricity storage system, which includes: a plurality of rectennas having a predetermined length and configured to collect a magnetic field among microwaves radiated from a high voltage cable and convert the collected magnetic field into electric energy; a current converter configured to convert the electric energy outputted from the rectennas into a storable current; and a charging tank configured to store the converted current, wherein the rectennas are spaced apart from the high voltage cable by a predetermined distance and arranged in a form of a fence so that a magnetic field does not affect a human body.

In accordance with another aspect of the present invention, there is provided an apparatus for harvesting energy from a microwave radiated from a system with an antenna, which includes: a plurality of rectennas configured to absorb a microwave radiated in an unwanted direction among microwaves radiated from the antenna and convert the absorbed microwave into electric energy; a current converter configured to convert the electric energy outputted from the rectennas into a storable current, and a charging tank configured to store the current outputted from the current converter, wherein the rectennas are spaced apart from the antenna by a predetermined distance in the unwanted direction and arranged in a certain form to shield the microwave.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a conceptual diagram explaining a method for harvesting energy from a microwave by using an existing solar cell system in accordance with an embodiment of the present invention.

FIG. 2 is a conceptual diagram explaining an energy harvesting method using a microwave radiated from a base station in accordance with an embodiment of the present invention.

FIG. 3 is a conceptual diagram explaining an energy harvesting method using a microwave generated around a high pressure power station and a transformer substation in accordance with an embodiment of the present invention.

FIG. 4 illustrates an array structure of a rectenna for harvesting energy in accordance with an embodiment of the present invention.

FIG. 5 is a conceptual diagram explaining an energy harvesting apparatus using an EMI microwave generated from high-power wireless facilities and communication equipment in accordance with an embodiment of the present invention.

FIG. 6 is a conceptual diagram explaining an energy harvesting apparatus using microwave energy radiated from side lobes among microwaves radiated from a general antenna in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Exemplary embodiments set forth herein may be modified in many different forms, and these embodiments are provided so that this disclosure will fully convey the concept of the invention to those skilled in the art. In the drawings, antennas, devices, or buildings are exaggerated or illustrated in different forms for clarity.

Prior to description of embodiments with reference to the accompanying drawings, an overview of the invention will be presented.

Wireless microwaves always exist around us. Examples of the wireless microwaves include microwave generated from a power station, EMI generated from a wireless device, and RF wave, microwave and millimeter wave always existing in the atmosphere.

The present invention relates to an apparatus for harvesting energy from these microwaves. Unlike a solar heat, microwaves always exist. Meanwhile, damage is often caused by EMI, or microwave environment is frequently misunderstood. Therefore, the present invention is directed to providing methods for ensuring stable and regular energy around us, under serious concerns about microwave environment problems and exhaustion of petroleum energy.

Methods for harvesting energy in accordance with embodiments of the present invention will be described below.

A first embodiment of the present invention relates to a method that uses an existing power collector where a rectenna is further installed in a solar cell which has been widely applied. The rectenna is a power collecting antenna made of a transparent conductor.

A second embodiment of the present invention relates to a method that generates new electricity by using EIRP radiated from a near base station and ensures safety from microwave outputted from the base station.

A third embodiment of the present invention relates to a method that ensures safety around a high pressure power station and a transformer substation, while reproducing electric energy from a magnetic field, which is a main cause of microwave generated at a high pressure power station.

A fourth embodiment of the present invention relates to a microwave energy reproducing method employing a method for shielding strong EMI generated in a communication and electric system with high power consumption.

A fifth embodiment of the present invention relates to an electric energy reproducing method that uses energy corresponding to side lobes among radiation patterns in order to control and shield microwave radiated from a communication repeater, a broadcast repeater and a base station to other areas.

### First Embodiment

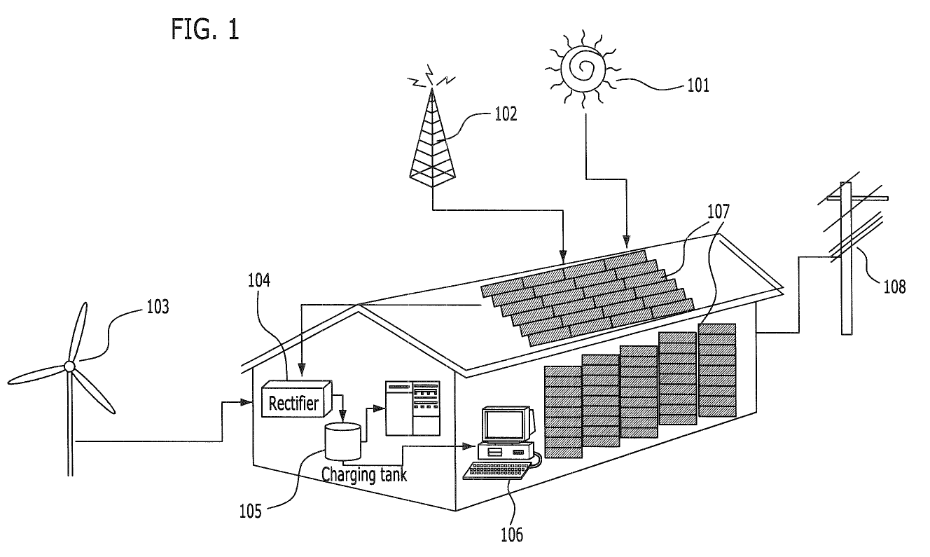

FIG. 1 is a conceptual diagram explaining a method for harvesting energy from a microwave by using an existing solar cell system in accordance with a first embodiment of the present invention.

Generally, most private homes or offices such as buildings receive AC power from an external transformer 108, and most electronic appliances use electric energy by employing an AC-DC converter. However, since a large amount of energy is lost during the conversion process, many studies have been conducted to reduce the number of AC-DC conversions by providing a DC power supply system.

Therefore, in the new energy reproduction technology, energy is stored and used by employing a DC storage battery for a DC power supply.

A representative new energy reproduction technology is to use the sun 101. Electricity is generated by using light and heat radiated from the sun 101. As the method using the sun 101, there is a solar heat technology and a photovoltaic power generation technology. In the following description, the sun 101 means both the solar light and the solar heat. In the case where the sun 101 means the solar light and the case where the sun 101 means the solar heat, the same reference numeral is used.

The solar heat technology uses a heat collector to convert solar radiant energy into heat energy, and the photovoltaic power generation technology uses a solar cell to convert a solar radiant energy into an electric energy. The solar heat technology is a photothermal field using a wave property of the sun's rays and is applied to air conditioning of buildings and water heating through absorption, storage and heat conversion of the solar heat 101. The photovoltaic power generation technology directly converts the solar light 101 into electric energy and generates power by using a solar cell which generates electricity due to the photoelectric effect when receiving the sunlight.

A photovoltaic power generation system includes a solar cell module 107, a rectifier 104 used as a power converter, and a charging tank 105 configured to store a rectified DC current.

The solar cell module 107 is installed in the roof or exterior of the building, where an amount of sunshine is sufficient, in order to receive a large amount of the solar light 101. Energy generated from the solar cell module 107 by the use of the solar light 101 rectifies an AC current into a DC current having one direction through the rectifier 104. The DC current outputted from the rectifier 104 is stored in the charging tank 105 and used in a computer 106 or other household electric appliances.

In addition to the solar heat 101, a wind power generator 103 is used as another new and renewable energy technology. The wind power generator 103 generates induced electricity by converting the kinetic energy of the wind into torque and supplies the induced electricity to power systems or consumers.

The wind power generator 103 includes a momentum conversion system configured to absorbing and converting energy of the wind power, a power transmission system, a power conversion system, and a control system. The respective components that store the electric energy by using the wind power are mutually coupled to function as a whole system. The induced electricity generated during the execution of the function is converted into a DC current trough the rectifier 104 and stored in the charging tank 105.

The current stored in the charging tank 105 by the solar heat 101 or the wind power generator 103 may be used in household electric appliances. However, the solar heat 101 or the wind power generator 103 has a changeability, that is, the quantity of energy generated is changed according to circumstances.

Microwave has a very low energy, compared with the wind power or the solar heat 101, but it radiates the same energy at all times. Also, since microwave has less variable factors, the system can be easily configured. Furthermore, compared with the solar cell using semiconductor, the antenna configuration is inexpensive and simple.

The rectenna, which is an antenna configured to collect power from microwave, is a compound word of “antenna” and “rectifier.” The antenna is configured to receive microwave, and the rectifier is configured to convert the received microwave into electric energy. In order to receive maximum power, the rectenna has a matching circuit and input/output impedance different from those of a general antenna. Like the general antenna, the rectenna may be fabricated in various configurations. Among them, a patch configuration is advantageous to a packaging and easy to fabricate in an array form because of its two-dimensional structure.

In addition, the rectenna may be made of a transparent conductor or a general conductor. Power generated through the rectenna may be used in the rectifier 104 and the charging tank 105, which is the existing renewable energy system, without modifications. Hence, additional installation and fabrication costs can be remarkably reduced.

Furthermore, the rectenna may be fabricated using an inexpensive painting scheme. The rectenna configured by applying the painting scheme to a transparent conductor may be fabricated in a planar type and used by attaching on the solar cell module 107. If the rectenna is implemented with the transparent conductor, energy can be ensured twofold by overlapping the rectenna on the solar cell. In addition, the rectenna may be attached to the outer wall of the building, the top of the building, or the window where energy can be easily collected. The rectenna may convert the absorbed microwave into electric energy. If a desired microwave is absorbed through the rectenna, the rectenna resonates at a specific frequency. Accordingly, if using a frequency function, the length of the rectenna may be determined according to the frequency of the microwave.

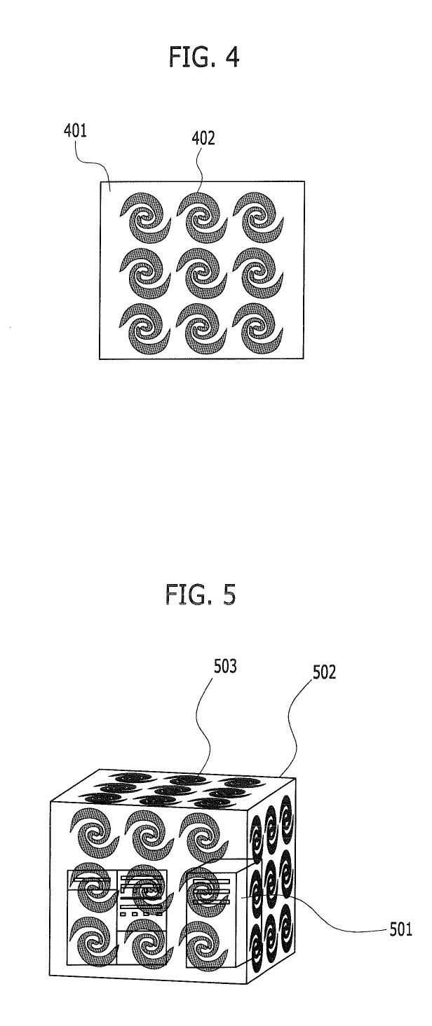

Moreover, as illustrated in FIG. 4, the rectenna may be arranged in an array form in order to improve energy received through the power collecting antenna.

FIG. 4 illustrates an array structure of a rectenna for harvesting energy in accordance with an embodiment of the present invention.

In the case of one energy collecting antenna 402, an amount of energy collected is small. Hence, a plurality of antennas 402 are arranged in an array form. Compared with the case of using one antenna 402, an energy collecting antenna unit 401 configured in an array form can increase an amount of energy received. When designing the energy collecting antenna unit 401 in the array form, the antennas 402 must be arranged considering antenna area and inter-antenna interference.

The energy collecting antenna 401 may be fabricated not in an antenna structure but in a resonance structure or an electromagnetic induction structure. In particular, in the case of using the rectenna to collect low frequency microwave, the resonance structure and the electromagnetic induction structure may be advantageous.

As described above, the use of the power collecting antenna can solve the problems of microwave generated inside the house or existing around the house. That is, various kinds of microwaves generated in a living space can be removed, and the electric energy can be reproduced by using the microwave.

### Second Embodiment

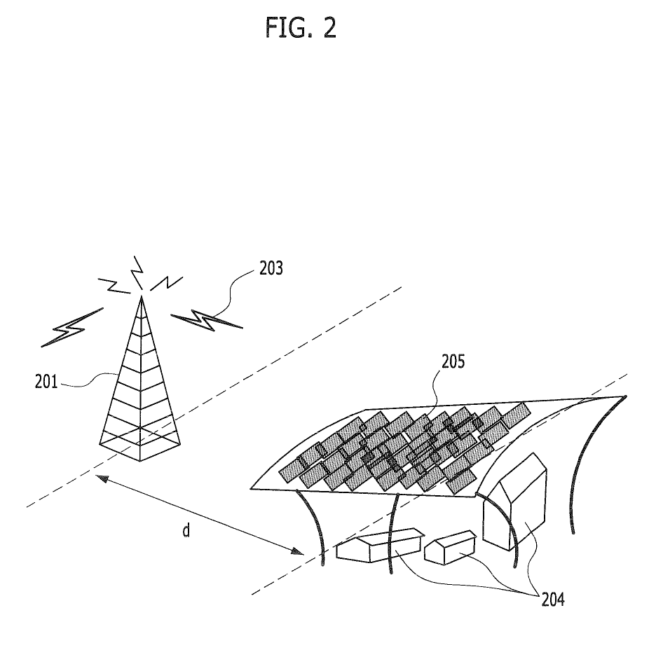

FIG. 2 is a conceptual diagram explaining a method for harvesting energy from a microwave radiated from a base station in accordance with a second embodiment of the present invention.

For convenience of life, a large number of mobile communication base stations 201 are installed around us. However, the intensity of microwave will be very strong if the mobile communication base stations 201 are installed at locations very near from the house or village 204. The above-described example is not limited to the mobile communication base station, and may include a broadcast repeater and so on. In this case, a shield 205 may be installed in order for stable communication and protection of the house or village 204 from the strong microwave 203.

Like the embodiment of FIG. 4, the shield 205 may be configured in an array form, or may be made of a transparent conductor and installed over the village, considering an amount of sunshine. The shield 205 is not limited to the embodiment of FIG. 5, and may be modified in various forms. For example, the shield 205 may be installed in a fence form.

Furthermore, the installation of the shield 205 makes it possible to receive the strong microwave 203 radiated from the mobile communication base station 201 and then reproduce energy.

Generally, the energy radiated from the mobile communication base station 201 is EIRP of more than 10,000 W. The radiant energy decreases with the inverse square of distance (d). As one example, in the case of using the existing rectenna technology and charging technology, the energy of 480 mW is produced at the distance of 1 m in the antenna area of 6×6 cm², the energy of 4.8 mW is produced at the distance of 10 m, and the energy of 48 μW is produced at the distance of 100 m. Also, the energy of 13.3 mW is produced at a distance of 100 m in the antenna area of 1 m², and the energy of 1.3 W is generated in the antenna area of 10 m².

### Third Embodiment

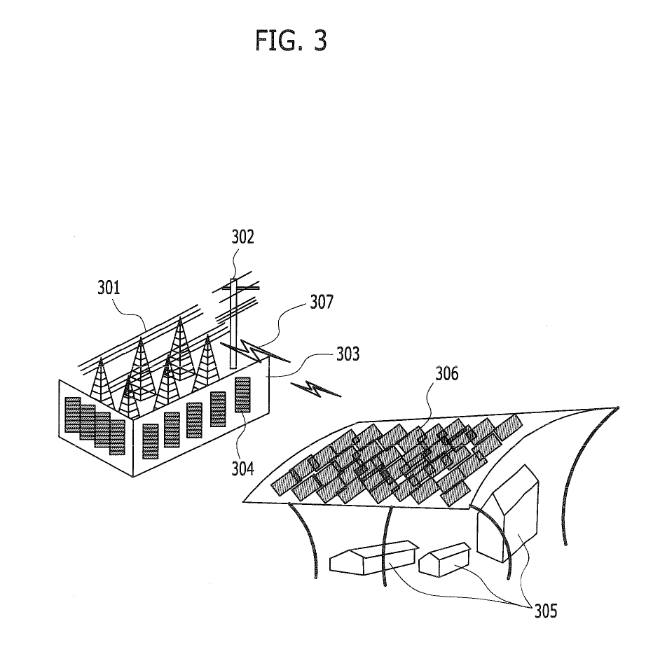

FIG. 3 is a conceptual diagram explaining a method for harvesting energy from a microwave generated around a high pressure power station and a transformer substation in accordance with a firth embodiment of the present invention.

The high pressure power station or transformer substation 301 or the high-voltage power transmission line 302 is considered as obnoxious facilities, and persons are reluctant to live around there. This is because persons are concerned about damage from microwave exposure because low frequency microwave is generated from those places. A low frequency generates a strong magnetic field. The control of such a magnetic field may be impossible even by the installation of a high fence.

Therefore, the method of FIG. 3 is to keep a magnetic field, which is a main cause among microwaves generated at the high pressure power station, reproduce electric energy, ensure the safety around the transformer substation, and harvest energy by using the magnetic field.

As an antenna for detection of a magnetic field, a low-impedance loop antenna is generally used. Like the embodiment of the present invention, when a frequency is very low just like microwave radiated from the high pressure power station and the transformer substation, magnetic field components can be collected by using a resonant loop antenna or an inductive coil.

In this embodiment, the resonant loop antenna, the magnetic resonator, and the electromagnetic induction coil for removing the magnetic field 307 may be fabricated in a form indicated by reference numeral 304, and they are arranged around the fence 303 so that microwave is prevented from leaking out of the high pressure power station 301 and the high-voltage power transmission line 302. Also, the magnetic field 307 and the microwave collected at the fence 303 configured with the above-described components are prevented from leaking out and converted into electric energy. That is, by providing a reproduction unit (not shown) for storing energy by converting energy of the magnetic field and so on collected at the fence 303 into an electric form, energy stored in the electric condenser (not shown) may be used.

Furthermore, by installing the shield 306 as well as the fence 303 at the village 305 near the high pressure power station 301 or the high-voltage power transmission line 302, like the embodiment of FIG. 2, energy can be reproduced by collecting microwave that is not prevented by the fence 303. Moreover, the installation of the shield 306 can protect the house or village 305 from microwave.

### Fourth Embodiment

FIG. 5 is a conceptual diagram explaining an energy harvesting apparatus using EMI microwave generated from high-power wireless facilities and communication equipment in accordance with a fourth embodiment of the present invention.

The high-power wireless facilities or communication/electric system 501 consumes high power, which may cause strong EMI. Therefore, a method for protecting from EMI and reproducing energy by collecting EMI noises will be described below.

An energy collecting antenna 503 is installed in the outside of the high-power wireless facilities or communication/electric system 501 in order to remove EMI noises generated when driving the high-power wireless facilities or communication/electric system 501. As described above, the energy collecting antenna 503 may be implemented in an array antenna type, and a printing scheme may be applied on a transparent substrate. In the case of applying the printing scheme on the transparent substrate as described above, operation states of the high-power wireless facilities or communication/electric system 501 can be easily confirmed. Furthermore, microwave radiated from the high-power wireless facilities or communication/electric system 501 can be removed. Moreover, after collecting microwave, the collected microwave may be converted into electric energy and then stored, or may be immediately supplied to other equipment as an energy source.

In the antenna array arrangement method, as illustrated in FIG. 5, antennas are arranged on all sides in order to completely shield EMI generated in the system. In this manner, leaking noises can be reduced, and energy can be reproduced by using EMI leaking from the system.

### Fifth Embodiment

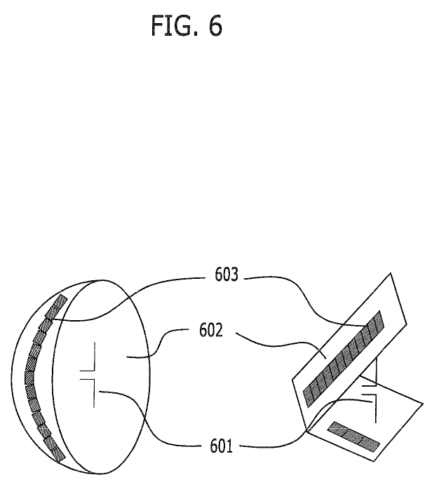

FIG. 6 is a conceptual diagram explaining an energy harvesting apparatus using microwave energy radiated from side lobes among microwaves radiated from a general antenna in accordance with a fifth embodiment of the present invention.

The fifth embodiment of the present invention is directed to providing a method for reproducing electric energy by using energy corresponding to side lobes among radiation patterns in order to control and shield microwave radiated from the communication/broadcast repeater and the base station to other areas.

In this embodiment, an energy collecting antenna 603 is installed in the rear side of the communication/broadcast antenna 601 or the region belonging to the side lobes. The installation of the energy collecting antenna 603 makes it possible to obtain energy by using microwave unnecessary to communication. The receiving energy can be increased by implementing the energy collecting antenna 603 in an array antenna type. A reproduction unit (not shown) may be provided for converting the collected energy into an electric form and then storing energy, and the energy stored in an electric condenser (not shown) can be used.

Moreover, the radiation direction of the communication/broadcast antenna 601 can be stabilized by adjusting the position and angle of the energy collecting antenna 603. That is, the energy collecting antenna 603 is installed at the position corresponding to the side lobes among the radiation patterns of the communication/broadcast antenna 601, considering the angle of the energy collecting antenna 603. By installing the energy collecting antenna 603 in the above-described manner, microwave radiated to other areas is blocked. Thus, the interference problem can be solved, and the energy can be harvested.

The energy harvesting apparatus in accordance with the embodiments of the present invention can ensure a stable energy source, solve energy harvesting limitation caused by existence of variable parameters and so on, and reduce influence of microwave on a human body.

While the present invention has been described with respect to the specific embodiments, it will be apparent to those skilled in the art that various changes and modifications may be made without departing from the spirit and scope of the invention as defined in the following claims.

What is claimed is:

1. An apparatus for harvesting energy from a microwave in an electricity storage system of a building, the apparatus comprising:
a plurality of rectennas arranged with a predetermined length according to characteristic of microwave to be absorbed, and configured to collect microwave in the atmosphere and convert the collected microwave into electric energy;
a current converter configured to convert the electric energy outputted from the rectennas into a storable current; and
a charging tank configured to store the current outputted from the current converter,
wherein the arranged rectennas are attached to an outer wall of the building, and the rectennas attached to the top of the building are printed in a transparent conductor on the surface of a solar cell.

2. The apparatus of claim 1, further comprising a wind power generator configured to generate induced electricity by using wind power and provide the induced electricity to the charging tank.

3. The apparatus of claim 1, further comprising a plurality of rectennas configured to collect microwave generated from a device generating microwave inside the building, convert the collected microwave into an electric current, and provide the electric current to the current converter.

4. The apparatus of claim 3, wherein the rectennas are printed on a transparent conductor in array type, and four sides of the device generating the microwave are shielded by the rectennas, thereby preventing leakage of the microwave.

5. The apparatus of claim 1, wherein, in case where a mobile communication repeater or a broadcast repeater is installed in the outside or top of the building, the apparatus further comprises a plurality of array rectennas configured to prevent microwaves generated at the mobile communication repeater or the broadcast repeater from flowing into the building, and to convert the microwave generated at the mobile communication repeater or the broadcast repeater into electric energy.

6. A system for harvesting energy from a microwave in an electricity storage system, the system comprising:
a plurality of rectennas having a predetermined length and configured to collect a magnetic field among microwaves radiated from a high voltage cable and convert the collected magnetic field into electric energy;
a current converter configured to convert the electric energy outputted from the rectennas into a storable current; and
a charging tank configured to store the converted current,
wherein the rectennas are spaced apart from the high voltage cable by a predetermined distance and arranged in a form of a fence so that a magnetic field does not affect a human body.

7. The system of claim 6, wherein the fence is made of a transparent conductor, and the array rectennas are printed on the fence.

8. The system of claim 6, wherein the fence is configured in a resonance structure or an electromagnetic induction structure.

9. The system of claim 6, wherein, in case where a mobile communication repeater or a broadcast repeater is installed in the outside or top of the building near the electricity storage system, the system further comprises a plurality of array rectennas configured to collect a microwave generated from the mobile communication repeater or the broadcast repeater and convert the collected microwave into electric energy.

10. The system of claim 9, wherein the array rectennas are spaced apart by a predetermined distance and arranged in a form of a fence so that the microwave does not affect a human body.

11. An apparatus for harvesting energy from a microwave radiated from a system with an antenna, the apparatus comprising:
a plurality of rectennas configured to absorb a microwave radiated in an unwanted direction among microwaves radiated from the antenna and convert the absorbed microwave into electric energy;
a current converter configured to convert the electric energy outputted from the rectennas into a storable current, and
a charging tank configured to store the current outputted from the current converter,
wherein the rectennas are spaced apart from the antenna by a predetermined distance in the unwanted direction and arranged in a certain form to shield the microwave.

12. The apparatus of claim 11, wherein, when the antenna is a parabolic antenna, the rectennas are arranged on a rear plate of the parabolic antenna to absorb a microwave radiated in a rear direction among microwaves radiated from the parabolic antenna and convert the absorbed microwave into electric energy.

13. The apparatus of claim 12, wherein the rectennas are implemented on a transparent conductor by using a printing scheme.

14. The apparatus of claim 11, wherein, when the antenna is a dipole antenna, the rectennas are arranged to absorb a microwave radiated in an unwanted direction among microwaves radiated from the antenna and convert the absorbed microwave into electric energy.

15. The apparatus of claim 14, wherein the rectennas are implemented on a transparent conductor by using a printing scheme.
